(19) United States
(12) Patent Application Publication
(10) Pub. No.: US 2008/0179386 A1
(43) Pub. Date: Jul. 31, 2008

(54) ATM DISPENSABLE NON-CASH MEDIA SHEET WITH SEPARABLE FOLDING CARD AND PROCESS OF DISPENSING FROM AUTOMATED TELLER

(76) Inventors: Daniel Oberan, Mesa, AZ (US); Aaron G. Vaughn, Mesa, AZ (US); Derek B. Cook, Mesa, AZ (US); Murdoch Henretty, Palm Desert, CA (US); Stephen Lloyd Oberan, Salem, OR (US); Thomas E. Honey, Scottsdale, AZ (US); Todd L. Nuttall, Gilbert, AZ (US)

Correspondence Address: DYKAS, SHAVER & NIPPER, LLP, P.O. BOX 877, BOISE, ID, 83701-0877, US

(21) Appl. No.: 11/776,382

(22) Filed: Jul. 11, 2007

Related U.S. Application Data
(63) Continuation-in-part of application No. 11/553,119, filed on Oct. 26, 2006.

(51) Int. Cl. G06F 17/00; G06K 19/06

(52) U.S. Cl. 235/375; 235/494

(57) ABSTRACT

The invention is a non-cash media sheet for use in an automatic teller machine or like device, from which one or more cards can be separated from the sheet. Two of the cards are joined along a fold line, and fold into a transaction card with a thickness similar to standard transaction cards and readable by readers of standard thickness transaction cards.

### CROSS-REFERENCE TO RELATED APPLICATIONS

This application is a continuation-in-part art application of application Ser. No. 11/553,119, filed Oct. 26, 2006, entitled NON-CASH MEDIA CARD AND PROCESS FROM AUTOMATED TELLER, which is pending, and incorporated herein by this reference.

### FIELD OF THE INVENTION

The present invention generally relates to a non-cash media which is dispensed to a user, and more particularly to a non-cash media sheet which has value, and which is dispensed to a user through an automatic teller machine, and which is foldable to form a transaction card of standard thickness.

### DESCRIPTION OF RELATED ART

Automated teller machines (ATM's) were introduced in the early 1970's and were preceded by automated cash dispensers a few years earlier in Europe. These are machines that dispense cash to a user, typically after the user inserts a transaction card with electronically encoded information, such as name and account number. The value of the cash dispensed is deducted from one of the user's bank deposit or credit accounts and appears on the user's bank statement. Currently, ATM's can be found in the lobbies of banks, in drive-through installations, in malls, in gasoline service stations, in grocery stores, in airports and in any convenient place where a customer may need to obtain cash.

It is common that ATM's also dispense certain non-cash documents, such as receipts, or information about a client's account balance. These documents are printed within the machine upon demand, and are typically produced and presented through a separate delivery slot than that through which the cash is presented to customers.

There are also specialized non-ATM machines presently available for use by consumers that dispense such objects as stamps, or in other configurations, prepaid phone cards that entitle the user to a certain monetary value of phone transactions. These machines are configured to dispense a particular item; either stamps, phone cards, transaction cards, tickets, or other types of output. Due to their specialized function, slow-market acceptance, and reluctance by retail location for new capital investments it is impractical to offer to the customer a wide selection of prepaid cards or cash dispensed from these machines. An ATM is a desirable venue from which to dispense transaction cards, since they can't be shoplifted, misplaced, or damaged as can cards from a store display, and by using the convenience of a monitored ATM, a secure and immediate recorded bank transaction showing useful and purposeful data identifying the specifics of this financial transaction are allowed.

Also, because a card dispensed from a currency cassette of an ATM must have the same dimensions as the currency the cassette is made for, such a card is thinner than a standard transaction card. What is needed is a card which may be dispensed from an ATM machine which has value to the user and which is selectable by the user through an ATM interface, and which can provide a transaction card of a thickness acceptable to the ATM manufactures operating tolerances for dispensing cash or non-cash from an ATM cassette and of such design, tolerance, dimensions as to be acceptable by transaction reading devices.

Additional objects, advantages and novel features of the invention will be set forth in part in the description that follows, and in part will become apparent to those skilled in the art upon examination of the following, or may be learned by practice of the invention. The objects and advantages of the invention may be realized and attained by means of the instrumentalities and combinations particularly pointed out in the appended claims.

### SUMMARY OF THE INVENTION

According to the present invention, the foregoing and other objects and advantages are obtained by a non-cash media sheet for use in an automatic teller machine (ATM) or like device (e.g. automated cash dispensers). The ATM would be configured for use with a selected currency, with a number of cassette trays for holding bills of different denominations of that currency. Since the currency of different nations are of different dimensions from each other, ATM machines are made and configured to process currency of a variety of dimensions. However, no ATM machine is made that can process and dispense a credit-card sized card of 2″×3″, or other cards of similar size. Also, no ATM is configured to dispense credit card sized cards of the thickness of standard transaction cards (i.e.: credit card, debit card, transit pass, etc.). This size of card is desirable because the purchaser can carry such a card in the same way he carries credit cards, in a wallet, purse, or pocket. If the card is the same thickness as a standard transaction card, it can be used in standard card readers in the same way as a credit card is used. The non-cash media sheet of the invention is configured to be one or more cards and to correspond to the requirements of any of these ATM machines, by being dispensed from a cassette of an ATM machine.

The dispensable sheet of the invention may be made of paper, plastic, polyvinyl, a hybrid of these or other materials which are suitable for handling characteristics for ATM machines. The design includes one or more attached panels or cards of standard or nonstandard size, with the ability to detach from each other and from the sheet, and to hinge to an adjacent card. This offers the ability to have a folded over card (or cards) with increased rigidity and thickness. This could offer the ability to have an end result of several cards that are separated from a main sheet.

The card dimensions are only limited to the ATM cassette dimensions. These cassettes are used inside ATM's, teller-like machines, or secure cash dispensing machines for both foreign and domestic currency and are designed for the purpose of securing media in preparation to dispense media from a cassette through the ATM designed delivery method.

By providing two or more attached cards, separable from the dispensed sheet and foldable with an adjacent card, a transaction card is provided which results in the thickness of a standard transaction card, even though the dispensed sheet is less than the thickness of a standard transaction card.

The non-cash media sheet of the invention would typically be dispensed from an ATM or similar device, and could be in the form of multiple kinds of transaction cards, also called stored value card (SVC) media normally purchased as single individual items from an open J-hook within a store, online from a provider and mailed or from a prepaid card-vending device that offers only a single kind of card (e.g. phone cards), but offers the protection of a secure box.

The ATMs dispensing the sheet of the invention would offer a selection of multiple kinds of SVC media and/or other non-cash media such as collectible cards, event tickets or passes and offers the ability to service customers at an unmanned point of sale device, like an ATM or other teller-like device.

The customer provides identification to the machine, just like at an ATM or teller-like machine, and the machine validates the customer. Once the customer is validated and approved for the purchase, the customer can then select from the ATM interface the SVC media or non-cash media desired, by using a cross section of number and alpha character buttons, or through an electronic display screen or other means of allowing the customer to specify the desired media or non-cash media or cash if offered at the machine. This machine would also incorporate sensors with the ability to identify and track each item purchased.

As the customer makes the purchase, the system reads the specific identification code on the media or item dispensed carrying an identification code or and knows the type of cards purchased or item dispensed. The machine then dispenses the sheet and may deliver a message verbally and/or visually to the customer. This verbal/visual message can refer to a bonus attached to the card, or an entertaining message or any other message desired to be delivered to the customer at the point of purchase. Once the identification code on each media sheet or card is read, value can be assigned to that code that would be later readable by a transaction card reader. The identification code could be a bar code, a magnetic identifier, printed information, or other stored information. What is meant by transaction card includes not only debit and credit card type cards, but also other stored value cards, like transit passes, and also gift certificates, gas card and event passes.

In addition to assigning value to a card by associating the identification code with an assigned value, the card itself can be modified by adding information to a memory region, a magnetic strip, an RFID chip, optical storage or other electronic.

Another aspect of the invention is the process of dispensing and identifying cash or non-cash media sheets dispensed from an ATM or other cash dispensing machine.

The process begins with the step of loading a quantity of selected non-cash media sheets containing separable cards with paired cards being foldable into a thicker and more rigid card, into a designated ATM cassette (or into a cash cassette adjusted for the specific requirements designated to fit the dispensing requirements of the media), and loading management software required to identify, track and dispense the cards, with the non-cash media sheets having characteristics and attributes similar to currency. The proprietary management or menu software or existing programmable software of the ATM is programmed so that the ATM knows that the media in a specified cassette is cash, non-cash media or other media. The menu software is programmed to display an ATM menu screen with an option to select the non-cash media or other media.

The next step is identification and validation of the customer and the customer's banking account by the ATM, and then the customer is offered a menu showing options they can select at the ATM. The next step is for a customer to select a non-cash media sheet with one or more removable and foldable cards from a menu presented by the menu software.

The next step is for the customer to select the option of cash or a non-cash media sheet, after which the selected non-cash media sheet moves through the same ATM mechanism that cash follows, and the media is read, identified and processed for tracking by a sensor before the non-cash media is dispensed. The cash or non-cash media may also be read by one or more sensors as the non-cash media is dispensed. The data that is read through the sensors is stored in a database and communicated to a host command to reconcile the transaction to the identification code number or other identification mechanism on the card or item just dispensed.

The next step occurs after the non-cash media sheet or sheets are dispensed, when the ATM has confirmed that the sheet or sheets were dispensed, at which time the system will update inventories and report to the host bank and the acquiring bank and any other companies appropriately involved in the transaction process.

An optional step is for the ATM machine to assign a value and identification information to a recordable and readable storage media or device on the sheet, so that the any card or cards removed from the sheet may be used as a transaction card with value. Value can be assigned by associating value in the banking system with the identification code of each card. Once the identification code on each media sheet or card is read, value can be assigned to that code that would later be readable by a transaction card reader. The identification code could be a bar code, a magnetic identifier, printed information, or other stored information. What is meant by transaction card includes not only debit and credit card type cards, but also other stored value cards, like transit passes, and also gift certificates, and event passes.

In addition to assigning value to a card by associating the identification code with an assigned value, the card itself can be modified by adding information to a memory region, such a magnetic strip, an RFID chip, optical storage, or other electronic media.

The non-cash media sheet of the invention is a sheet which is dispensed by the ATM, and which has the same dimensional tolerances for the largest width and length dimensions of currency that can be dispensed by the ATM, and which has the capability of being associated with a particular transaction with a user, as by a printed account or serial number, bar code, or other printed or embedded indicia and/or electronically encoded or recorded information that can be read visually or by electronic means specific to each card. The non-cash media card or cards which can be separable from the sheet forms a transaction card by folding along an edge with an adjacent backing card, and has a value to the user and can be used by the user in exchange for goods, services access to events or transportation.

Cards which may be dispensed and which have value could include the so-called “closed loop” system as well as branded (Visa and MasterCard) stored value or prepaid cards, admission tickets to events, cards with RFID tags for transportation access or locations, cards with encoded memories, such as phone cards or gasoline cards, cards with computer chips with encoded memory, collectable cards, cards with punch outs for goods or services, bar codes, cards redeemable for goods and services, or any other card-like instrument which has value to the consumer. To be dispensable from ATM machines, the sheet has to have dimensions and characteristics that correspond to the cash dispensing cassette parameters of the ATM machine. From such an ATM dispensable sheet, one configuration could contain a separable card which is attached to an adjacent backing card, and the two cards fold into a single card approximating the thickness and appearance of a credit card in shape and length and width proportions. The pair of cards are removable or “detached” from the ATM dispensable sheet. The detached card could be a pass to an event, or contain encoded memory information, or be any of the previously listed embodiments of the card. If it contained encoded memory information, this card could be updated with new memory information, which could augment the value remaining on the card. Since the dispensed sheet is equal to the size of currency dispensed by that particular ATM machine, and a smaller card is removable from the dispensed sheet, the dispensable card presents the opportunity for advertising, instructions, or other information to be presented to the user.

Accordingly, this invention provides a non-cash media sheet that can be dispensed by ATM and ATM-like machines using the same apparatus and machinery processes that dispenses cash from ATM and ATM-like machines, and which has separable cards which fold to form a transaction card or non-cash media card of approximately the same thickness as standard transaction cards.

The characteristics of the non-cash media sheet with separable folding cards will be similar to the selected undamaged currency that the ATM processes in terms of the side edge characteristics, the flex and stiffness tolerances, the roughness tolerances, the thickness tolerances, the weight tolerances, the tear tolerances, the length and width tolerances, the porosity tolerances and the contrast ratio opacity tolerance. Each of these parameters is important for interacting with the machinery of the ATM, and for verification of authenticity.

The non-cash media card could be a so-called “closed loop” system as well as branded (Visa and MasterCard) stored value or prepaid card, ticket allowing entry to an event or a location. It could also be a collectible card, such as a card for a sports figure or to commemorate an event. If the card involves stored memory, each subsequent transaction could reduce the remaining value chargeable on the card. Some uses of this card could be for telephone charges or for gasoline purchases, but obviously could be utilized for any purchase or access for which a card reader is available. For a non-cash media sheet as described above which contains a separable portion with information storage media, the value chargeable to the card can be augmented by a subsequent transaction in an appropriate machine or by the user at the ATM machine by making a phone call, by online or broadband access, by face-to-face transaction, or to other industry acceptable ways of augmenting value. The non-cash media card of the invention could be imprinted with information about the purchaser and about the transaction of buying the card. Due to this information, the card can be tracked as it is used, and value can be uploaded to the card subsequent to the original transaction. The imprinting of the information can be as information stored on the memory media of the card, and can be by a bar code or numbers and/or other indicia imprinted on the card. The bar code and/or other information can be preprinted on all the cards loaded into the ATM machine, or can be printed on each card as it is purchased and dispensed. If such information is preprinted, the transaction information is sent from the ATM to a computing center, and the purchaser and transaction information is associated with such information at that point. Bar code or other identifying information can be imprinted in a printing process with ink, by a laser marking process, or other means of making a visible symbol. Bar code type information can also be imprinted by electronic means, as electronic data on a magnetic, optical or other storage medium. Another way that information can be associated with the transaction is by the use of RFID, or Radio Frequency Identification or transponder-like means. An RFID or transponder-like tag is an object that can be attached to or incorporated into a product, animal, or person for the purpose of identification using radio waves. Chip-based RFID tags contain silicon chips and antennas. Passive tags require no internal power source, whereas active tags require a power source. It has been dubbed the “contactless” card or system for doing what the other transaction cards do, but is encoded with the same information as is conveyed in a bar-code. A file is set up on the card to be attached to that specific frequency and every time the non-cash media card is used with that frequency the user is identified.

The invention is also a process for dispensing a non-cash media sheet which is associated with a particular transaction, from an ATM machine through the same mechanism through which cash is dispensed.

The non-cash media sheet and the process of the invention thus provide a card and a process for dispensing the card through an ATM machine and associating that card to an individual purchaser and the original transaction. This provides a secure environment for dispensing a variety of value added cards which is not presently available. The secure environment has the unexpected benefit of reducing shrinkage due to losses from theft. This is also an unexpected use of an ATM machine. This also presents an opportunity for companies to advertise goods or services on the card, and allows a seller of goods or services to sell a customer a non-cash media card which is redeemable at a later date with or without the use of a magnetic card reader or other value added storage devices.

Still other features and advantages of the present invention will become readily apparent to those skilled in this art from the following detailed description describing preferred embodiments of the invention, simply by way of illustration of the best mode contemplated by carrying out my invention. As will be realized, the invention is capable of modification in various obvious respects all without departing from the invention.

### BRIEF DESCRIPTION OF THE DRAWINGS

Accordingly, the drawings and description of the preferred embodiments are to be regarded as illustrative in nature, and not as restrictive in nature.

FIG. 1 is a plan view of a non-cash media sheet of the invention.

FIG. 2 is a non cash media sheet of the invention which includes three cards which are a gift certificate, and two free product offerings.

FIG. 3 is the non cash media sheet of figure three, showing the opposite side of the non-cash media sheet with cards which include a magnetic strip card, and two free product offerings.

FIG. 4 is a flow diagram is the process of the invention.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

In the following description and in the figures, like elements are identified with like reference numerals. The use of “or” indicates a non-exclusive alternative without limitation unless otherwise noted. The use of “including” means “including, but not limited to,” unless otherwise noted.

The preferred embodiment of the invention is a non-cash media sheet which is dispensed from an automated teller machine (ATM) or ATM-like machine (e.g. automated electronic cash dispenser), which includes one or more separable cards which fold to form a transaction card, and in which the card can be associated with an individual purchaser and transaction.

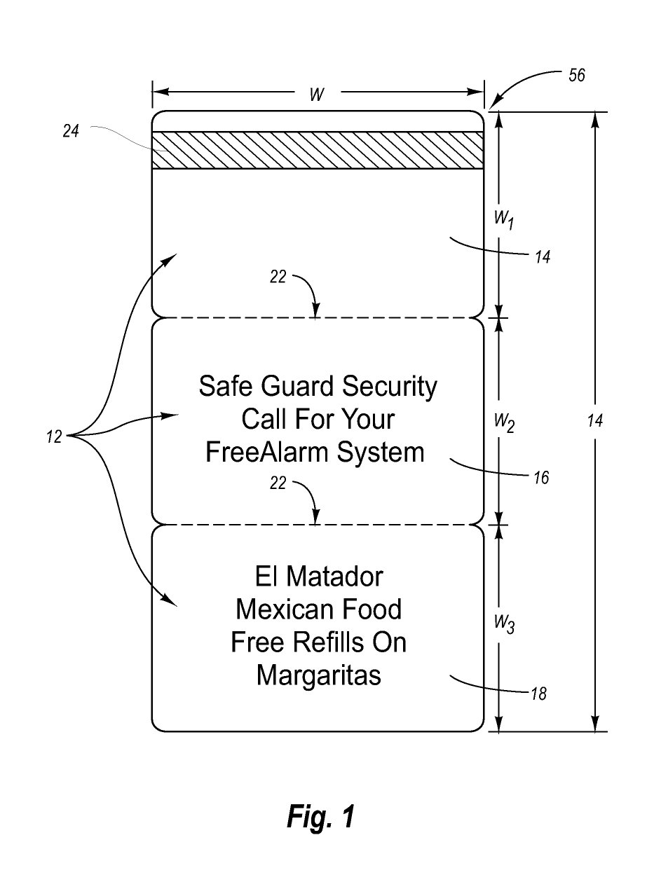

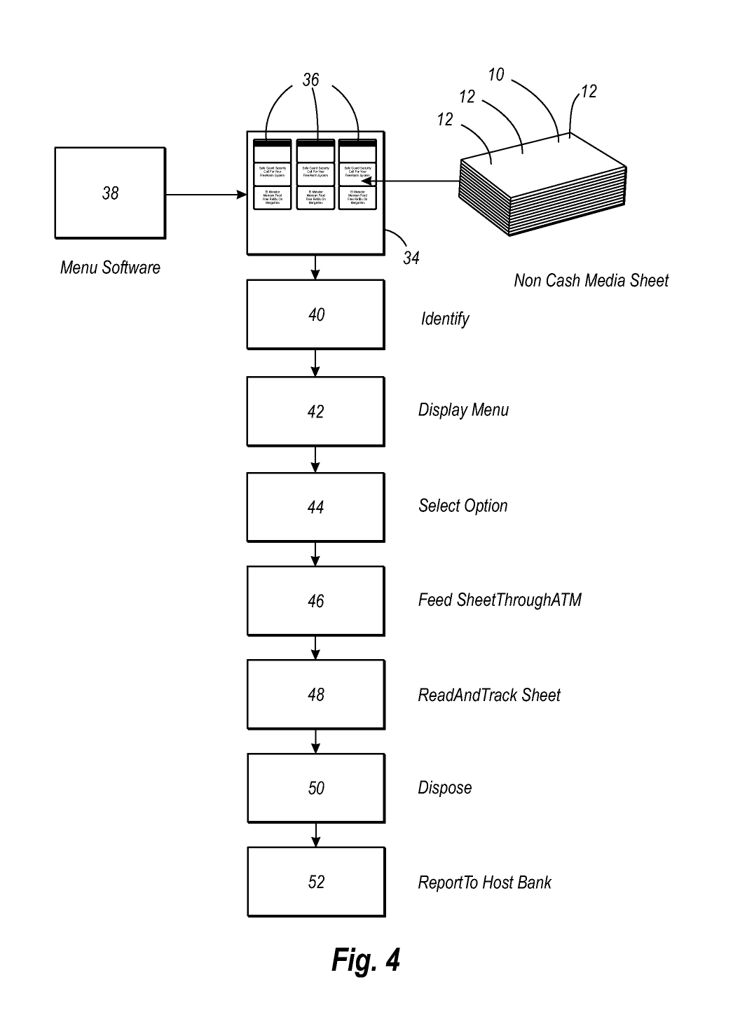

The FIGS. 1 through 4 show the preferred form of the invention. FIG. 1 shows the non-cash media sheet 10 of the invention, with three cards 12 defined within the non-cash media sheet 10. Preferably, two of the cards would separate from the third card in this configuration, and the primary card 14 and a backer card 16 would fold together to form a transaction card approximately equal in thickness to a standard transaction card, such as credit or debit card.

In the case of a non-cash media sheet 10 configured to be dispensed from an ATM for U.S. currency, the sheet 10 would have a width W of 3.125 inches, and a length L of 6.1875 inches. The sheet 10 shown in FIG. 1 includes a primary card 14, adjacent to a backing card 16, and a supplemental card 18. In this configuration, the primary card 14 is joined to the backing card 16 by a score rule 20, which is added to facilitate folding of the two cards. The supplemental card 18 is attached to the backing card 16 by a cress cut rule 22, which facilitates separation of the two cards. Together, the three cards 12 form the non-cash media sheet 10 of the invention, and the primary card 14 and the backing card 16 fold together to form a separate transaction card.

When dispensed from U.S. currency compatible ATMs, the primary card 14 is equal in length to the width of the non-cash media sheet 10, at 3.125 inches, and its width W1 is 2.0625 inches. In the embodiment shown in FIG. 1, the backing card 16 would have a width W2 of 2 inches. The supplemental card 18 would have a width W3 of 2.125 inches.

The primary card 14 of the sheet 10 includes a mag strip 24. The mag strip 22 is a magnetic strip on which digital information can be stored, such as a stored value, and user identification information.

Another preferred embodiment of the invention is one in which the three cards 12 are equal in width at 2.0625 inches. By way of example, the cards in this configuration could be joined by a cress cut rule 22 or a score rule.

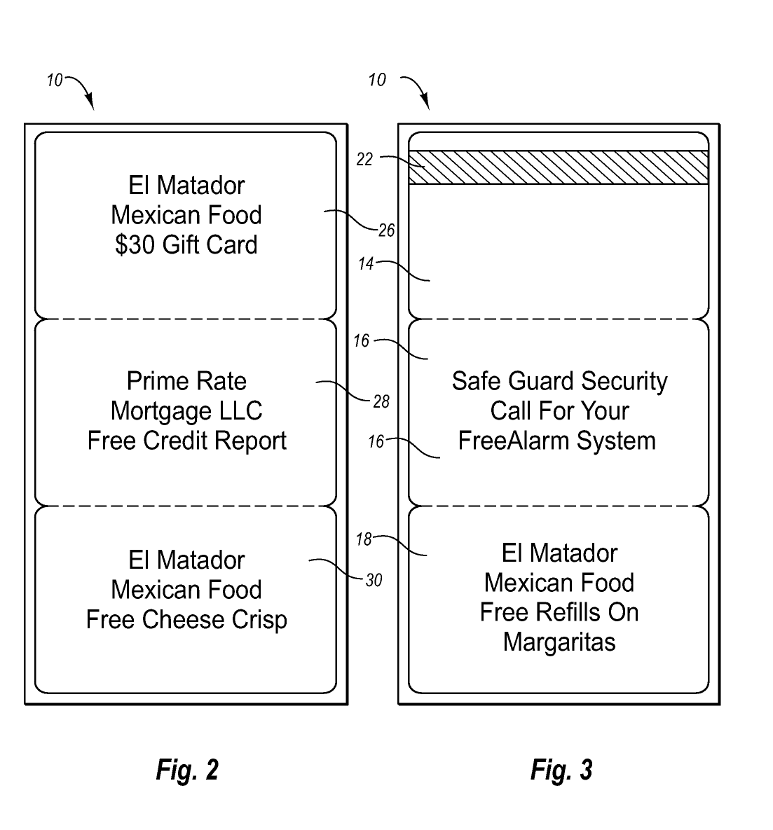

FIG. 3 and 2 are examples of some cards of value that can be included in the non-media sheet 10 of the invention. These options include a gift certificate, a business card with an offer of free services 28, and a free product certificate 30. FIG. 3 includes a transaction card 28 with a mag strip, which can include as a backing card 16 an card with advertising 32. In FIG. 3 the supplemental card is an advertising card 32.

The non-cash media sheets of the invention can be either paper, plastic or polyvinyl or a hybrid of these, or other materials which have characteristics compatible with ATM feed mechanisms. Preferably, the non-cash media sheet of the invention has a thickness of about 13 mm, so that when folded in half a transaction card of about 26-27 mm is formed, which approximates the 30 mm thickness of a standard transaction card such as a credit card.

The non-cash media sheet is dispensed from the ATM using the same pathway and mechanism that cash follows through the ATM. The non-cash media sheet includes at least a pair of separable cards (primary card and a backing card) which fold to form a transaction card of the same approximate thickness as a standard transaction card. The transaction card of the invention could contain a bar code, a magnetic strip, an RFID tag, an optical device, biometric technology or other prevalent technology used for the specific identification of that single non-cash media card or a combination of these technologies could be employed.

If the customers selects the option of non-cash media or other media, the media moves through the same ATM mechanism that cash follows, and the media is read, identified and tracked by one or more sensors before the non-cash media is dispensed or the media is read by sensors as the non-cash media is dispensed. This data that is read through the sensors is stored on a database and communicated to a host command to reconcile the transaction to the number (or other identification mechanism) on the card just dispensed.

After the sheet or sheets are dispensed, and the ATM has validated that the sheets were dispensed, the system will update the host command inventories and report to the host bank and the acquiring bank and any other companies appropriately involved in the transaction process.

The card-reading sensor on the ATM could be designed to read a bar code, a magnetic strip, an RFID tag, an optical strip, biometric identifier, or other prevalent technology used for the specific identification of the specific non-cash media card that was then identified, tracked and dispensed by the ATM together with any proprietary or non-proprietary software required.

Another feature of the invention is the capability of the ATM being configured to read the non-cash media sheet 10 after the media is loaded into the media cassette and secured inside the ATM, or after the media is loaded into a cash cassette adjusted for the specific requirements designated to fit the dispensing requirements of the media and then secured in the ATM. Accordingly, the driver software and the ATM software is programmed to identify the media that is in the ATM and to register the quantity of media in the ATM along with the amount or value stored on the recordable data storage of the media in the ATM. This information is registered and stored into a database.

Optionally, the value recorded on the mag strip 22 of any card may be programmed based on information entered by the customer, and dispensed with a stored value determined by the customer. The ATM in such a configuration is equipped with a data encoder to enter data on mag strips for instance as each card is being processed. Other devices for recording data could also be used to read and write data to a card, such as RFID format information, optical readers, magnetic information, or other forms.

Tracking of a specific card 12 which is dispensed may be accomplished in various ways, each with a different level of complexity. The first level would be that in which the alignment of the bar codes and/or printed indicia represent specific information held in a database on a server or other means. The second level of media storage would be exemplified by mag-strips and holograms where embedded information is actually added to the card (whether magnetic, optical, RFID, or other storage means) that also can be more specific but also refer back to another database or file held on a server or other. The third level would be the chip-set where an actual computer chip or RFID chip or biometric device would hold real information in its own data file yet can also be used to access data in a data file on an independent server.

This may be accomplished by a card preprinted with a bar code and/or other indicia, in which the ATM dispensing the card would be configured to read the bar code as the card is dispensed. The ATM of this system could also be configured to encode the card with information specific to the purchaser and a particular transaction. This could be by an imprinting function in the ATM, or by a memory updating function by which the purchaser and transaction specific information is encoded onto the storage memory of the card.

This card is preferably made from any number of different plastic materials, polyester (which does not leave a track mark), of which any number of formulations would be appropriate. The dimensions and tolerances of the card are such that it is compatible with the cash handling apparatus of an ATM machine. Specifically, the card may be from 4 to 33 millimeters thick. For an ATM machine that is configured to handle a nation's currency, the ATM dispensable card could range from 55 to 83 millimeters (2″) in width and from 100 to 181 millimeters in length. Its weight is 65 to 95 grams per square meters. It's bendsden roughness is from 200 to 1200 ml per minute. Its taber stiffness (in the cross direction) is 0.8 to 2.4 (machined direction) is from 1.2 to 4.0. Its bendsden velocity is 150 mils per minute. Its single tear (machined direction) is a minimum of 230 mN. Its single tear (cross direction) is a minimum of 270 mN. Its contrast ratio opacity (including inking) is a minimum of 79%.

While maintaining these physical characteristics, the non-cash media card can be configured to serve as an admission ticket to events or locations. It can also be configured to carry an image which makes the card collectible, such as an image of a sports figure. The card can be configured with “punch-outs” for goods or services, in which a region of the card is removed to indicate that goods have been received or a service has been performed. When all of the punch-outs of the cards are utilized, the user would have to buy a new card with punch-outs. The cards themselves may also be redeemable for goods or services, such as a car wash, a carpet cleaning, a hot air balloon ride, or any number of goods or services. The card could also have regions with encoded memory on which subsequent transactions would be recorded to diminish or augment the stored value on the card. The memory could be in the form of magnetic strip or strips, computer chips, RFID tags, bar codes, holograms, optical recognition or other means of storing or transferring data.

In another preferred embodiment of the invention, the non-cash media sheet is configured to be within the ranges of dimensions specified by the ATM manufacturer, and of the same tolerances as noted above, and the possibility of having a detachable portion which approximates the appearance of a credit card in shape and length, and width proportions but not necessarily with the same dimensions and thickness of a standard sized credit card. This version would have the ability to form a transaction card by folding in half, to form a transaction card with the general thickness of a credit card. This detachable portion can be configured as in the embodiment described above, to act as a pass to events, or as a collectible, and to carry stored information in a memory storage device. In both of these configurations, the non-cash media card can be printed to display promotional information in addition to serving the purpose for which the card was purchased.

Each card will have an identification element for associating the card to a particular purchaser and a particular transaction. The identification element on the sheet may be on the front or back, and may be on one or more of the removable portion of the sheet.

A convenient and easy way to integrate a tracking and validation system for identifying bar codes, mag-stripes, optical recognition or RFID tags and/or other indicia into the ATM dispensing system is to incorporate and interface writer/reader sensor system within the dispensing and storage mechanism of the ATM. In one configuration, as the sheet is first picked from the ATM cassette it will be detected by a sensor being a writer /reader device that reads the bar code or other specific information coded indicia information on the card. As each sheet is picked up by the dispensing mechanism and travels through the dispensing channel, a series of sensors for identification, validation, security and default detection continue to validate, identify and check for any defaults or problems before being presented to the outlet tray of the ATM. At the point of final checking the item being presented has been processed, identified and cleared for delivery to customer conducting business at the ATM or banking device.

The information relating to the user and the transaction is stored in the memory of the ATM like any other cash transaction, plus it is sent to the processor and disseminated to the appropriate banking computers and networks which perform the ATM transactions. The ATM transaction processing system will have the capability of tracking the card and linking it to the account that purchased it from the ATM. When the card is purchased it is by way of credit card, ATM card or debit card where pertinent account holder information is accessed during the transaction. This permits the processors and banking entities attached to each file to identify which cards were purchased by what type of payment instrument, who purchased the card, for tracking purposes and for the next step in allowing for a flexible load to the card.

“Flexible load” means the customer may now tell the ATM how much money to load or credit to the purchased card verses being limited to only pre-denominated cards in the ATM.

The identification code and/or other indicia are for tracking the card for inventory control AND for being able to link that card (file and number held on the server of the card issuer) to the purchaser. Linking the card to a particular purchaser allows the purchaser to reload the value on the card, or at the time of purchase to place a variable amount on the card rather than buying a pre-denominated value. It also has importance in creating a classification of the type of transaction as determined by VISA or MC and the processors. The ability to identify a transaction as a banking or EFT transaction verses a POS (point of sale) transaction only is a feature of the invention. An EFT transaction is a transfer of funds, other than a transaction originated by check, draft, or similar paper instrument, which is initiated through an electronic terminal, telephone instrument, or computer or magnetic tape to authorize a financial institution to debit or credit an account. POS is an electronic payment system in a merchant's location where consumers pay for retail goods and services, through the use of credit cards or debit cards that directly access and deduct funds from the customer's checking account.

When the ATM is used for any transaction, the card used to initiate the transaction identifies the person at the ATM and the user's banking account, or at least the account linked to the card and the user's personal identification number (PIN) information for verification and completion of the transaction. When they are identified their profile will contain all their account information on the bank's network and servers. This is the means through which the plastic card is linked to the customer, account numbers, and PIN numbers so they can be verified and the transaction completed.

With the customer now verified and having his profile accessed, the newly dispensed non-cash media sheet with its detachable and foldable cards which form a normal thickness transaction card can now be linked to his profile like any other card so if he chooses later to reload (adding more to the card) he can do so at the ATM or online. It also will give the system real time ability so if he chooses to place more funds (beyond the predenominated value) on the card at the time of purchase he can elect to do so with money from either his checking, savings account or credit account. Now this card belongs to him like his VISA debit or ATM card and he can add more money to the account that he has just opened as if transferring funds from one account to another.

An identification code and/or other indicia identifies the sheet for inventory control and then assigns the card to the purchaser. The identification code is the link to the server file of the card issuer only for that card. Once it is identified and tagged to the profile of the purchaser it becomes part of his new profile. We will know when it was purchased, where, by what profile and if any funds where added to it beyond the pre-denominated funds. The system will also be able to give the option of offering a card with no pre-denominated funds and lets the customer determine how much he would like on this transaction or stored value card.

In another preferred embodiment of the invention, the invention is a process for dispensing a non-cash media sheet from an ATM machine. The non-cash media sheet is a sheet as described above, which is selected by a user through the ATM interface, and dispensed from the ATM through the same apparatus and cassettes as that which is used to dispense cash.

As shown in FIG. 3, the process begins with the step of loading a quantity of selected non-cash media sheets 10, each containing one or more separable cards 12 with paired cards being foldable into a thicker and more rigid card, into a designated ATM cassette 36 (or into a cash cassette adjusted for the specific requirements designated to fit the dispensing requirements of the media). The ATM 34 is loaded with management software 38 to identify, track and dispense the sheets 10, with the non-cash media sheets 10 having characteristics and attributes similar to currency. The proprietary management or menu software or existing programmable software 38 of the ATM 34 is programmed so that the ATM knows that the media in a specified cassette is non-cash media or other media. The menu software 38 is programmed to display an ATM menu screen with an option to select the non-cash media or other media.

The next step is identification of the customer and validation by the ATM at box 40; customer is then offered a list of actions they can perform at the ATM at step 42. The next step is for a customer to select a non-cash media at box 44, with each sheet 10 includes one or more removable and foldable cards from a menu presented by the menu software.

After the selection step at box 44, the selected non-cash media sheet moves through the same ATM mechanism that cash follows, at box 46, and the media is read, identified and tracked by one or more sensors at box 48 before the non-cash media sheet 10 is dispensed at box 50. The non-cash media may also be read by one or more sensors as the non-cash media is dispensed. The data that is read through the sensors is stored in a database and communicated to a host command to reconcile the transaction to the number (or other identification mechanism) on the card just dispensed.

The next step occurs after the non-cash media sheet or sheets are dispensed, when the ATM has confirmed that the sheet or sheets were dispensed, at which time the system will update the host command inventories and report to the host bank and the acquiring bank and any other companies appropriately involved in the transaction process, at box 52.

An optional step is for the ATM machine to assign a value and identification information to a digital storage media strip on the sheet, so that the cards removed from the sheet may be used as a transaction card with value.

While there is shown and described the present preferred embodiment of the invention, it is to be distinctly understood that this invention is not limited thereto but may be variously embodied to practice within the scope of the following claims.

What is claimed is:

1. A non-cash media sheet for use in an automated teller machine configured for use with a selected currency, comprising:
a non-cash media sheet configured for dispensing from a cassette of any ATM, with said sheet comprising of a plurality of separable cards, with at least two or more of said cards being attached by a foldable edge seam (to a backing card), with said foldable cards being separable from said sheet and with said card or cards-comprising an identification code for tracking said card or cards when used as transaction cards, with said foldable cards being a transaction card meeting the specifications of reading devices for reading transaction cards.

2. The non-cash media sheet of claim 1 in which said sheet comprises two or more cards, with each card attached at a foldable seam, with each card being separable to form a transaction card of standard transaction card thickness.

3. The non-cash media sheet of claim 2 in which said one or more separable cards comprise at least one stored value which is depletable when used with used in commerce.

4. The non-cash media sheet of claim 1 in which said-card or cards include an adhesive portion for affixing said foldable card together in a back-to-back fashion.

5. The non-cash media sheet of claim 2 in which said non-cash media sheet is configured for storage in a cassette of an automated teller machine, for delivery by said automated teller machine, and comprised to meet dimensional tolerances of the currency dispensed by the automated teller machine, and which has value to the user and is used in commerce for the exchange of goods and services.

6. The non-cash media sheet of claim 5 which is comprised of the same side edge characteristics as the selected undamaged currency.

7. The non-cash media sheet of claim 5 which further comprises the same flex and stiffness tolerances as the selected undamaged currency.

8. The non-cash media sheet of claim 5 which further comprises the same roughness tolerances as the selected undamaged currency.

9. The non-cash media sheet of claim 5 which further comprises the same thickness tolerances as the selected undamaged currency.

10. The non-cash media sheet of claim 5 which further comprises the same weight tolerances as the selected undamaged currency.

11. The non-cash media sheet of claim 5 which further comprises the same tear tolerances as the selected undamaged currency.

12. The non-cash media sheet of claim 5 which further comprises the same length and width tolerances as the selected undamaged currency.

13. The non-cash media sheet of claim 5 which further comprises the same porosity tolerances as the selected undamaged currency.

14. The non-cash media sheet of claim 5 which further comprises the same contrast ratio opacity tolerances as the selected undamaged currency.

15. The non-cash media sheet of claim 5 in which said sheet comprises one or more tickets allowing entry to an event or location, or public transportation.

16. A process for dispensing a non-cash media sheet from a conventional ATM machine from cassettes of the ATM machine, comprising the steps of:
loading in said ATM a management software program comprising menu options for non-cash media sheets, to allow a customer to select a non-cash media product;
loading into a cassette of said ATM a quantity of non-cash media sheets;
identifying and validating the customer at an ATM customer interface;
offering said customer one or more menu options for selection, comprising the option of receiving a non-cash media sheet;
selecting an option of receiving a non-cash media sheet from the ATM customer interface;
routing said non-cash media sheet through the currency disbursement mechanisms of the ATM;
confirming said disbursement of said non-cash media sheet;
updating an inventory count of non-cash media sheets;
reporting transaction data to a card issuer; and
reporting transaction data to said customer's financial institution.

17. The process for dispensing a non-cash media sheet from a conventional ATM machine from cassettes of the ATM machine of claim 16, in which said step of loading a quantity of non-cash media sheets further comprises loading non-cash media sheets comprising one or more separable cards, with said cards separable from said sheet.

18. The process for dispensing a non-cash media sheet from a conventional ATM machine from cassettes of the ATM machine of claim 17, in which said step of loading a quantity of non-cash media sheets further comprises loading a quantity of non-cash media sheets with each sheet comprising two or more separable cards, and with at least two of said cards being joined by a fold line and configured for folding along said fold line to form a thicker and more rigid card.

19. The process for dispensing a non-cash media sheet from a conventional ATM machine from cassettes of the ATM machine of claim 17, further comprising the step of:
providing one or more cards on said media sheet with an identification code, and providing said ATM with an identification code writer/reader, with said customer selecting an amount of value to be assigned to one or more cards, and with said ATM identification code writer/reader enabling an assignment of a selected amount to said card.

20. The process for dispensing a non-cash media sheet from a conventional ATM machine from cassettes of the ATM machine of claim 18, which further comprises the step of:
providing one or more cards on said media sheets with an identification code, and providing said ATM with an identification code media writer/reader, with said customer selecting an amount of value to be assigned to one or more cards, and with said ATM identification code writer/reader enabling an assignment of a selected amount to said card.

21. The process for dispensing a folding non-cash media card from a conventional ATM machine from the cassettes of the ATM machine of claim 17, which further comprises the steps of:
providing said card on said media sheet with a unique identification code, and providing said ATM with an identification code writer/reader, with said code writer/reader reading said code of said card;
enabling tracking of the use of said card in future transactions by the customer.

22. The process for dispensing a folding non-cash media card from a conventional ATM machine from the cassettes of the ATM machine of claim 18, which further comprises the steps of:
providing one or more cards on said media sheet with a unique identification code, and providing said ATM with an identification code writer/reader, with said code writer/reader reading said code of one or more cards;
enabling tracking of the use of said card in future transactions by the customer.
